(19) United States
(12) Patent Application Publication
(10) Pub. No.: US 2025/0267448 A1
(43) Pub. Date: Aug. 21, 2025

(54) TEMPORARY UE CAPABILITY RESTRICTIONS FOR SIMULTANEOUS NETWORK CONNECTIONS

(71) Applicant: Intel Corporation, Santa Clara, CA (US)

(72) Inventors: Yujian Zhang, Beijing (CN); Youn Hyoung Heo, Sunnyvale, CA (US); Sudeep K. Palat, Cheltenham (GB); Seau S. Lim, Swindon (GB); Yi Guo, Shanghai (CN)

(21) Appl. No.: 18/859,357

(22) PCT Filed: Jul. 26, 2023
(86) PCT No.: PCT/US2023/028637

§ 371 Date: Oct. 23, 2024

Related U.S. Application Data
(60) Provisional application No. 63/393,028, filed on Jul. 28, 2022.
(60) Provisional application No. 63/393,745, filed on Jul. 29, 2022.
(60) Provisional application No. 63/483,490, filed on Feb. 6, 2023.

(51) Int. Cl. H04W 8/22; H04W 8/18; H04W 76/19; H04W 76/20

(52) U.S. Cl. CPC H04W 8/22; H04W 8/183; H04W 76/19; H04W 76/20

(57) ABSTRACT

A computer-readable storage medium stores instructions for execution by one or more processors of a UE to configure the UE for simultaneous connection with a 5G NR network and at least a second network, and to cause the UE to perform operations. The operations include encoding UE capability information for transmission to a base station. The UE capability information indicates the UE supports MUSIM operations. First RRC signaling received from the base station includes a plurality of MUSIM configurations to configure the UE for the MUSIM operations. Interference between at least one of the plurality of MUSIM configurations and operation of the UE on the at least second network is detected. Second RRC signaling is transmitted, which indicates a temporary UE capability restriction based on the interference.

### PRIORITY CLAIM

This application claims the benefit of priority to the following patent applications:
U.S. Provisional Patent Application No. 63/393,028, filed Jul. 28, 2022, and entitled “TEMPORARY UE CAPABILITY RESTRICTION FOR SIMULTANEOUS CONNECTION TO 2 OR MORE NETWORKS;”
U.S. Provisional Patent Application No. 63/393,745, filed Jul. 29, 2022, and entitled “ENHANCED FREQUENCY DIVISION MULTIPLEXING (FDM) SOLUTION FOR IN-DEVICE COEXISTENCE;” and
U.S. Provisional Patent Application No. 63/483,490, filed Feb. 6, 2023, and entitled “TEMPORARY UE CAPABILITY RESTRICTION FOR SIMULTANEOUS CONNECTION TO 2 OR MORE NETWORKS.”

Each of the above-listed applications is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, (MulteFire, LTE-U), and fifth-generation (5G) networks including 5G new radio (NR) (or 5G-NR) networks, 5G-LTE networks such as 5G NR unlicensed spectrum (NR-U) networks and other unlicensed networks including Wi-Fi, CBRS (OnGo), etc. Other aspects are directed to techniques for temporary user equipment (UE) capability restriction for simultaneous connection to two or more networks. Additional aspects are directed to enhanced frequency-division multiplexing (FDM) solutions for in-device coexistence.

### BACKGROUND

Mobile communications have evolved significantly from early voice systems to today's highly sophisticated integrated communication platform. With the increase in different types of devices communicating with various network devices, the usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next-generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As the current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed, as well as unlicensed spectrum, is expected in future releases and 5G systems. Such enhanced operations can include techniques for temporary UE capability restriction for simultaneous connection to two or more networks, as well as an enhanced FDM solution for in-device coexistence.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2, FIG. 3, and FIG. 4 illustrate various systems, devices, and components that may implement aspects of disclosed embodiments.

FIG. 5 illustrates an example abstract syntax notation (ASN) of configuring an indication in radio resource control (RRC) signaling as part of UE assistance information, in accordance with some aspects.

FIG. 6 illustrates an example ASN of configuring an indication in RRC signaling as part of UE assistance information, in accordance with some aspects.

FIG. 7 is a diagram of a media access control (MAC) control element (CE) to indicate a secondary cell (SCell) affected by a network (NW) (e.g., NW B), in accordance with some aspects.

FIG. 8 is a diagram of an example message sequence associated with the disclosed techniques, in accordance with some aspects.

FIG. 9 illustrates an example ASN of configuring an indication of affected frequency resource for duplex modes, in accordance with some aspects.

FIG. 10 illustrates an example ASN of configuring an indication of additional information provided by a base station, in accordance with some aspects.

FIG. 11 illustrates a block diagram of a communication device such as an evolved Node-B (eNB), a new generation Node-B (gNB) (or another RAN node), an NCR, an access point (AP), a wireless station (STA), a mobile station (MS), or user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

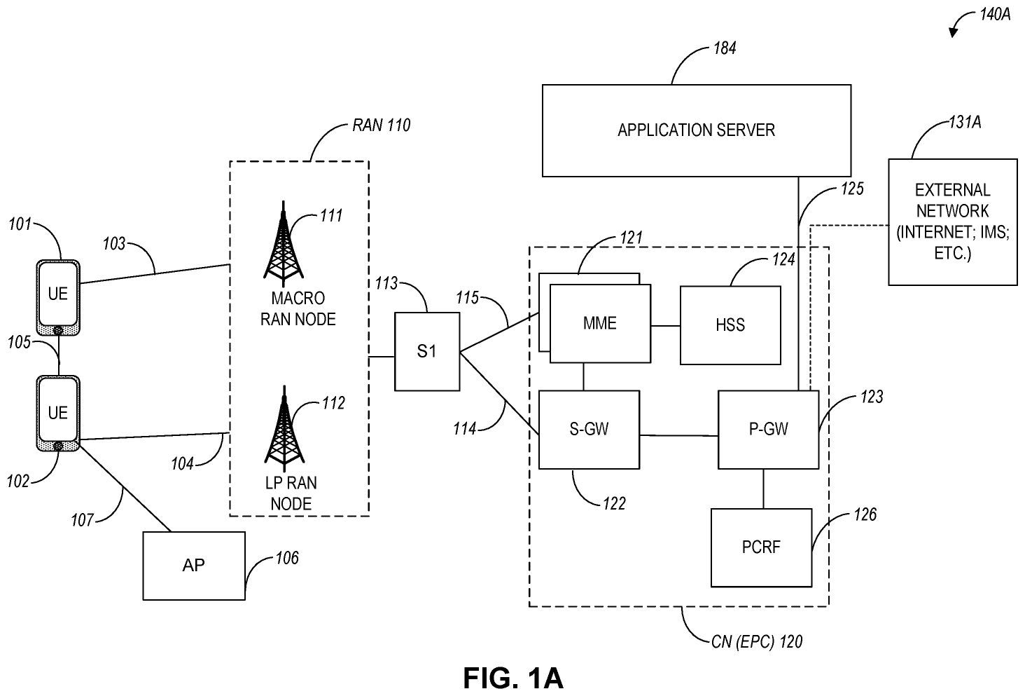

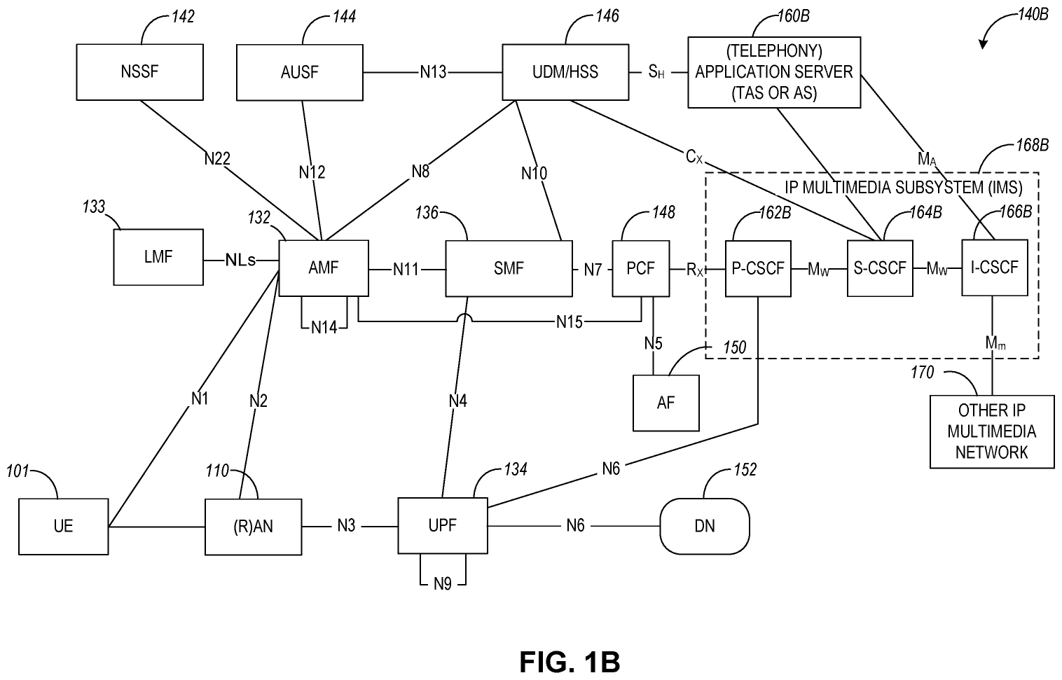

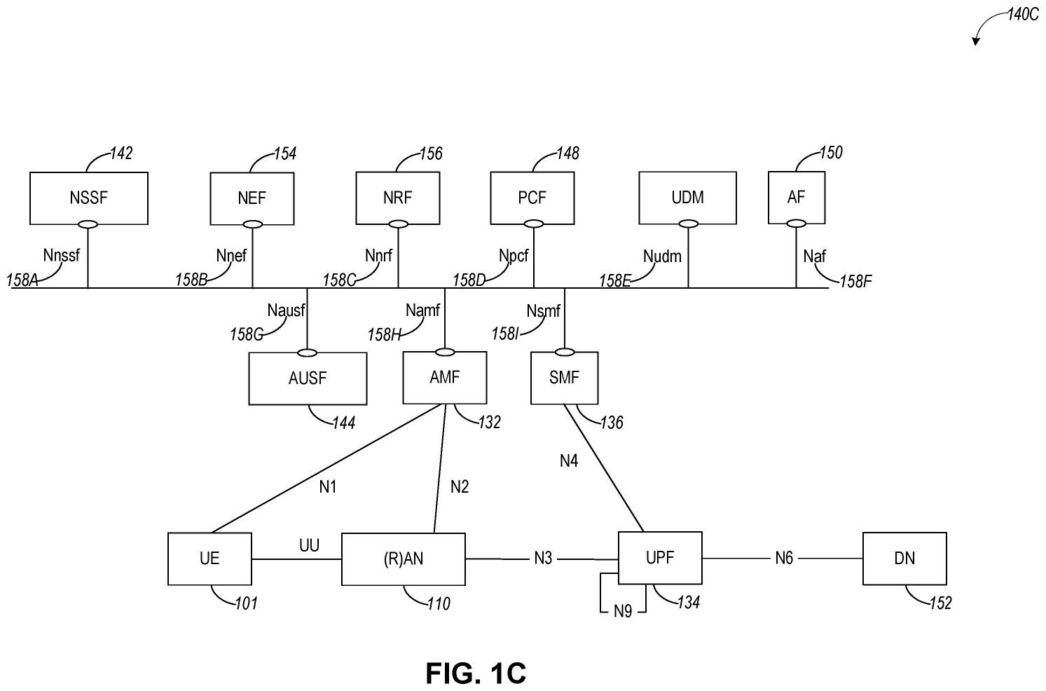

FIG. 1A illustrates an architecture of a network in accordance with some aspects. The communication network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. UE 101 and UE 102 can be collectively referred to herein as UE 101, and UE 101 can be used to perform one or more of the techniques disclosed herein.

Any of the radio links described herein (e.g., as used in the communication network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UE 101 and UE 102 can comprise an Internet-of-Things (IoT) UE or a Cellular IoT (CIOT) UE, which can comprise a network access layer designed for low-power IoT applications utilizing short-lived UE connections. In some aspects, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UE 101 and UE 102 can include enhanced MTC (eMTC) UEs or further enhanced MTC (FeMTC) UEs.

The UE 101 and UE 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN nodes, and one or more RAN nodes for providing femtocells or picocells (e.g., cells having smaller coverage areas, smaller user capacity, or higher bandwidth compared to macrocells), e.g., low power (LP) RAN node or an unlicensed spectrum based secondary RAN node.

Any of the communication nodes 111 and 112 can terminate the air interface protocol and can be the first point of contact for UE 101 and UE 102. In some aspects, any of the communication nodes 111 and 112 can fulfill various logical functions for the RAN 110 including, but not limited to, the radio network controller (RNC) functions such as radio bearer management, uplink and downlink dynamic radio resource management, and data packet scheduling, and mobility management. In an example, any of the communication nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the communication nodes 111 and 112 and the serving gateway (S-GW) 122, and the S1-mobility management entity (MME) interface 115, which is a signaling interface between the communication nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network (e.g., CN 120) and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120. The P-GW 123 may further be a node for policy enforcement and

charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G core network (e.g., CN 120). RAN 110 in an NG system can be referred to as NG-RAN. The RAN 110 can include a plurality of nodes, such as gNBs and NG-eNBs. The CN 120 (also referred to as a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the RAN 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170, e.g. an IMS operated by a different network operator.

In some aspects, the UDM/HSS 146 can be coupled to an application server (AS) 160B, which can include a telephony application server (TAS) or another AS. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, the 5G system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

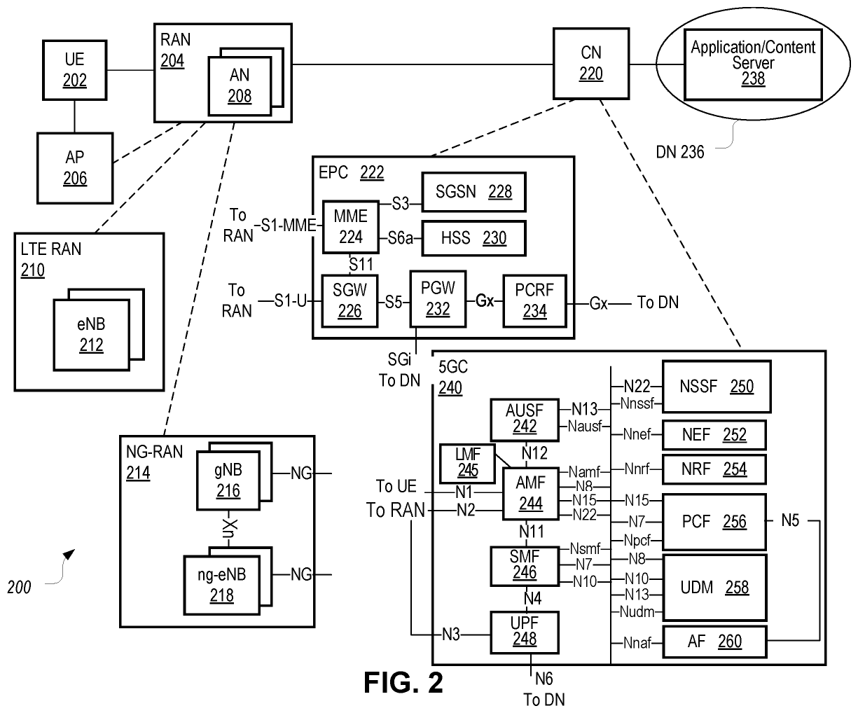

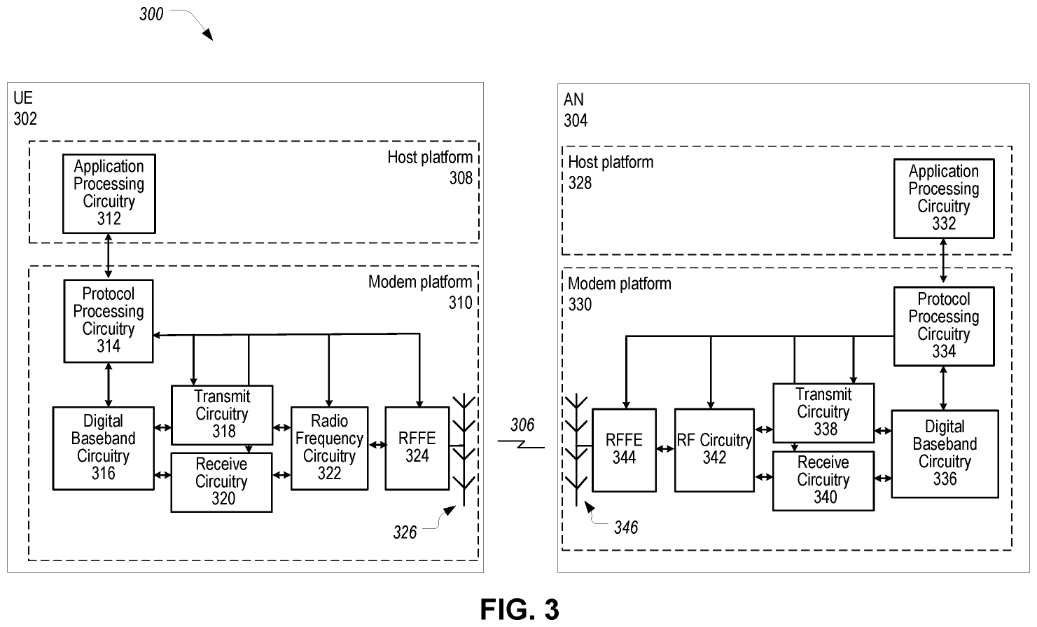

FIGS. 2-11 illustrate various systems, devices, and components that may implement aspects of disclosed embodiments in different communication systems, such as 5G-NR networks including 5G non-terrestrial networks (NTNs). UEs, base stations (such as gNBs), and/or other nodes (e.g., satellites or other NTN nodes) discussed herein can be configured to perform the disclosed techniques.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be but is not limited to, a smartphone, tablet computer, wearable computing device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, network 200 may include a plurality of UEs coupled directly with one another via a sidelink interface. The UEs may be M2M/D2D devices that communicate using physical sidelink channels such as but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 configured by the RAN 204 to utilize both cellular radio resources and WLAN resources.

The RAN 204 may include one or more access nodes, for example, access node (AN) 208. AN 208 may terminate air-interface protocols for the UE 202 by providing access stratum protocols including RRC, Packet Data Convergence Protocol (PDCP), Radio Link Control (RLC), MAC, and L1 protocols. In this manner, the AN 208 may enable data/voice connectivity between the core network (CN) 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low-power base station for providing femtocells, picocells, or other like cells having smaller coverage areas, smaller user capacity, or higher bandwidth compared to macrocells.

In embodiments in which the RAN 204 includes a plurality of ANS, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG, and a second AN may be a secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/SCells. Before accessing the unlicensed spectrum, the nodes may perform medium/carrier-sensing operations based on, for example, a listen-before-talk (LBT) protocol.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: sub-carrier spacing (SCS) of 15 kHz; CP-OFDM waveform for downlink (DL) and SC-FDMA waveform for uplink (UL); turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface but may connect with a UE via an LTE air interface. The gNB 216 and the ng-eNB 218 may connect over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS but may use PBCH DMRS for PBCH demodulation; PTRS for phase tracking for PDSCH and tracking reference signal for time tracking. The 5G-NR air interface may operate on FR1 bands that include sub-6 GHz bands or FR2 bands that include bands from 24.25 GHz to 52.6 GHz. The 5G-NR air interface may include a synchronization signal and physical broadcast channel (SS/PBCH) block (SSB) which is an area of a downlink resource grid that includes PSS/SSS/PBCH.

In some embodiments, the 5G-NR air interface may utilize BWPs (bandwidth parts) for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amounts of frequency resources (for example, PRBs) to support data transmission under different traffic loading scenarios. A BWP containing a smaller number of PRBs can be used for data transmission with a small traffic load while allowing power saving at the UE 202 and in some cases at the gNB 216. A BWP containing a larger number of PRBs can be used for scenarios with higher traffic loads.

The RAN 204 is communicatively coupled to CN 220 which includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be connected to the LTE radio network as part of the Enhanced Packet System (EPS) 222, which may also be referred to as an EPC (or enhanced packet core). The EPC 222 may include MME 224, SGW 226, SGSN 228, HSS 230, PGW 232, and PCRF 234 coupled with one another over interfaces (or “reference points”) as shown. Functions of the elements of the EPC 222 may be briefly introduced as follows.

The MME 224 may implement mobility management functions to track the current location of the UE 202 to facilitate paging, bearer activation/deactivation, handovers, gateway selection, authentication, etc.

The SGW 226 may terminate an S1 interface toward the RAN and route data packets between the RAN and the EPC 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track the location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable the transfer of subscription and authentication data for authenticating/authorizing user access to the LTE CN (e.g., CN 220).

The PGW 232 may terminate an SGi interface toward a data network (DN) 236 that may include an application/content server 238. The PGW 232 may route data packets between the LTE CN and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for the provision of IMS services. The PGW 232 may be coupled with a PCRF 234 via a Gx reference point.

The PCRF 234 is the policy and charging control element of the CN 220. The PCRF 234 may be communicatively coupled to the app/content server 238 to determine appropriate QoS and charging parameters for service flows. The PCRF 234 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for the authentication of UE 202 and handle authentication-related functionality. The AUSF 242 may facilitate a common authentication framework for various access types. In addition to communicating with other elements of the 5GC 240 over reference points as shown, the AUSF 242 may exhibit a Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to the management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnecting to data network 236, and a branching point to support multi-homed PDU sessions. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for the third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on the exposed capabilities of other NFs. This information may be stored at the NEF 252 as structured data, or a data storage NF using standardized interfaces. The stored information can then be re-exposed by the NEF 252 to other NFs and AFs, or used for other purposes such as analytics. Additionally, the NEF 252 may exhibit a Nnef service-based interface.

The NRF 254 may support service discovery functions, receive NF discovery requests from NF instances, and provide information on the discovered NF instances to the NF instances. NRF 254 also maintains information on available NF instances and their supported services. As used herein, the terms “instantiate,” “instantiation,” and the like may refer to the creation of an instance, and an “instance” may refer to a concrete occurrence of an object, which may occur, for example, during the execution of program code. Additionally, the NRF 254 may exhibit the Nnrf service-based interface.

The PCF 256 may provide policy rules to control plane functions to enforce them, and may also support a unified policy framework to govern network behavior. The PCF 256 may also implement a front end to access subscription information relevant to policy decisions in a UDR of the UDM 258. In addition to communicating with functions over reference points as shown, the PCF 256 exhibits an Npcf service-based interface.

The UDM 258 may handle subscription-related information to support the network entities' handling of communication sessions and may store the subscription data of UE 202. For example, subscription data may be communicated via an N8 reference point between the UDM 258 and the AMF 244. The UDM 258 may include two parts, an application front end, and a UDR. The UDR may store subscription data and policy data for the UDM 258 and the PCF 256, and/or structured data for exposure and application data (including PFDs for application detection, and application request information for multiple UE) for the NEF 252. The Nudr service-based interface may be exhibited by the UDR to allow the UDM 258, PCF 256, and NEF 252 to access a particular set of the stored data, as well as to read, update (e.g., add, modify), delete, and subscribe to the notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re) selection and traffic routing. Based on operator deployment, when AF 260 is considered to be a trusted entity, the network operator may permit AF 260 to interact directly with relevant NFs. Additionally, the AF 260 may exhibit a Naf service-based interface.

The data network 236 may represent various network operator services, Internet access, or third-party services that may be provided by one or more servers including, for example, application/content server 238.

In some aspects, network 200 is configured for NR positioning using the location management function (LMF) 245, which can be configured as an LMF node or as functionality in a different type of node. In some embodiments, LMF 245 is configured to receive measurements and assistance information from NG-RAN 214 and UE 202 via the AMF 244 (e.g., using an NLs interface) to compute the position of the UE. In some embodiments, the NR positioning protocol A (NRPPa) protocol can be used for carrying the positioning information between NG-RAN 214 and LMF 245 over a next-generation control plane interface (NG-C). In some embodiments, LMF 245 configures the UE 202 using LTE positioning protocol (LPP) (e.g., LPP-based communication link) via the AMF 244. In some aspects, NG-RAN 214 configures the UE 202 using, e.g., radio resource control (RRC) protocol signaling over, e.g., LTE-Uu and NR-Uu interfaces. In some aspects, UE 202 uses the LTE-Uu interface to communicate with the ng-eNB 218 and the NR-Uu interface to communicate with the gNB 216. In some aspects, ng-eNB 216 and gNB 216 use NG-C interfaces to communicate with the AMF 244.

In some embodiments, the following reference signals can be used to achieve positioning measurements in NR communication networks: NR positioning reference signal (NR PRS) in the downlink and sounding reference signal (SRS) for positioning in the uplink. The downlink positioning reference signal (PRS) can be used as a reference signal supporting downlink-based positioning techniques. In some aspects, the entire NR bandwidth can be covered by transmitting PRS over multiple symbols that can be aggregated to accumulate power.

FIG. 3 schematically illustrates a wireless network 300 in accordance with various embodiments. The wireless network 300 may include a UE 302 in wireless communication with AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318 receive circuitry 320, RF circuitry 322, RFFE 324, and one or more antenna panels 326 (referred to generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the one or more antenna panels 326, RFFE 324, RF circuitry 322, receive circuitry 320, digital baseband circuitry 316, and protocol processing circuitry 314. In some embodiments, the one or more antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and one or more antenna panels 326. In some embodiments, the transmit components of the UE 302 may apply a spatial filter to the data to be transmitted to form a transmit beam emitted by the antenna elements of the one or more antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The one or more processors 410 may include, for example, a processor 412 and a processor 414. The one or more processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The one or more communication resources 430 may include interconnection or network interface controllers, components, or other suitable devices to communicate with one or more peripheral devices 404 or one or more databases 406 or other network elements via a network 408. For example, the one or more communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the one or more processors 410 to perform any one or more of the methodologies discussed herein. The instructions 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of the one or more peripheral devices 404 or the one or more databases 406. Accordingly, the memory of the one or more processors 410, the memory/storage devices 420, the one or more peripheral devices 404, and the one or more databases 406 are examples of computer-readable and machine-readable media.

For one or more embodiments, at least one of the components outlined in one or more of the preceding figures may be configured to perform one or more operations, techniques, processes, and/or methods as outlined in the example sections below. For example, baseband circuitry associated with one or more of the preceding figures may be configured to operate in accordance with one or more of the examples set forth below. For another example, circuitry associated with a UE, base station, satellite, network element, etc. as described above in connection with one or more of the preceding figures may be configured to operate in accordance with one or more of the examples set forth below in the example section.

The term “application” may refer to a complete and deployable package, or environment to achieve a certain function in an operational environment. The term “AI/ML application” or the like may be an application that contains some artificial intelligence (AI)/machine learning (ML) models and application-level descriptions. In some embodiments, an AI/ML application may be used for configuring or implementing one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience concerning some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principal component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution as well as any online learning if applicable). The ML host informs the actor about the output of the ML algorithm, and the actor decides on an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

In Rel-15/16, the coordination between network (NW) A and NW B is left to UE implementation, while in Rel-17, the coordination between NW A and B is done via the NW A with gap request from UE or entering idle mode in NW A.

In Rel-18, 3GPP support for multiple universal subscriber identity module (MUSIM) devices to operate in RRC CONNECTED state simultaneously in 2 networks. In some aspects, the following configurations can be used by the disclosed techniques:

(a) Specify mechanism to indicate preference on temporary UE capability restriction and removal of restriction (e.g., capability update, release of cells, (de) activation of configured resources) with NW A when UE needs transmission or reception (e.g., start/stop connection to NW B) for MUSIM purpose.

(a.1) Radio Access Technology (RAT) Concurrency: Network A is NR SA (with CA) or NR DC. Network B can either be LTE or NR.

(a.2) Applicable UE architecture: Dual-RX/Dual-TX UE.

The disclosed techniques include mechanisms to indicate a preference for temporary UE capability restriction and removal of the restriction.

The Rel-16 power saving indication as well as overheating indication may not allow the UE to specifically indicate the component carrier or the SCell or the corresponding bandwidth and/or MIMO layers for the restriction. Hence the network may not have made the right restriction and provided the temporary UE capability restriction for MUSIM purposes to the UE as described herein.

In some aspects, the disclosed techniques can include indicating specifically the component carrier(s) and SCell(s) that the UE needs to temporarily restrict in NW A to satisfy the need to establish and maintain the services in NW B while the UE is in RRC Connected mode in both NW A and NW B and while keeping the static UE radio capability unchanged in both NW A and NW B. In addition, a network can also configure a limit on the number of CCs and for each CC, the number of MIMO layers, and the bandwidth that can be restricted/reduced.

As the UE indicates specifically the component carrier(s) and SCell(s) for the temporary UE capability restriction, the network can execute the restriction, and the UE can use that UE capability for NW B.

### UE Assistance Information

In some embodiments, any of the following information can be provided in an indication from the UE to network for the temporary UE capability restriction:

(a) The FrequencyInfoDL (SCS-SpecificCarrier, absoluteFrequencyPointA, FreqBandIndicatorNRs) for DL CC(s) which is no longer possible or if it is still possible, just that its corresponding number of MIMO layers needs to be reduced or the bandwidth location is restricted relative to the Frequency InfoDL.

(b) The FrequencyInfoUL (SCS-SpecificCarrier, absoluteFrequencyPointA, FreqBandIndicatorNRs) for DL CC(s) which is no longer possible or if it is still possible, just that its corresponding number of MIMO layers needs to be reduced or the bandwidth location is restricted relative to the Frequency InfoDL.

(c) If a CC is already configured, the SCellIndex can be provided instead of the DL/UL CC to indicate:
(c.1) whether the DL or UL or both are no longer possible; and
(c.2) If a DL or UL or both are still possible (e.g., indicates its corresponding number of MIMO layers needs to be reduced or the bandwidth location is restricted relative to the Frequency InfoDL.

(d) Restriction on which band.

(e) No restriction.

In some aspects, the UE provides all the restrictions to the network. Other than just indicating the bands that are no longer available to the network for the UE, the capability restriction can also include the corresponding band combinations that are no longer available. In another embodiment, the network infers/computes the restrictions on the list of band combinations from the previously provided UE capability based on the capability restriction of the bands that are no longer available signaled by the UE.

### UE Assistance Information (UAI) Format

The above information can be sent in the RRC message as part of the RRC UE assistance information or a new RRC message.

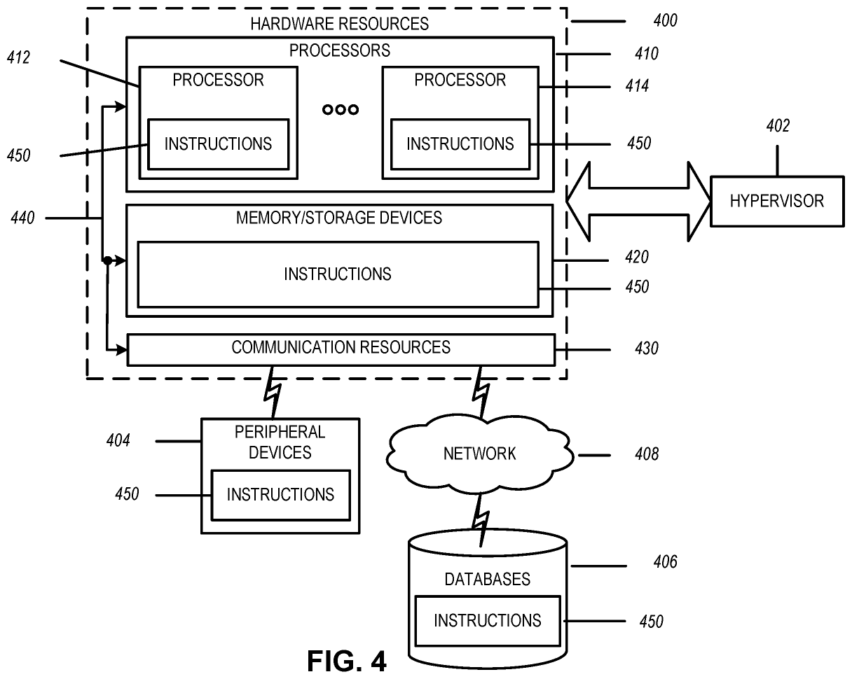

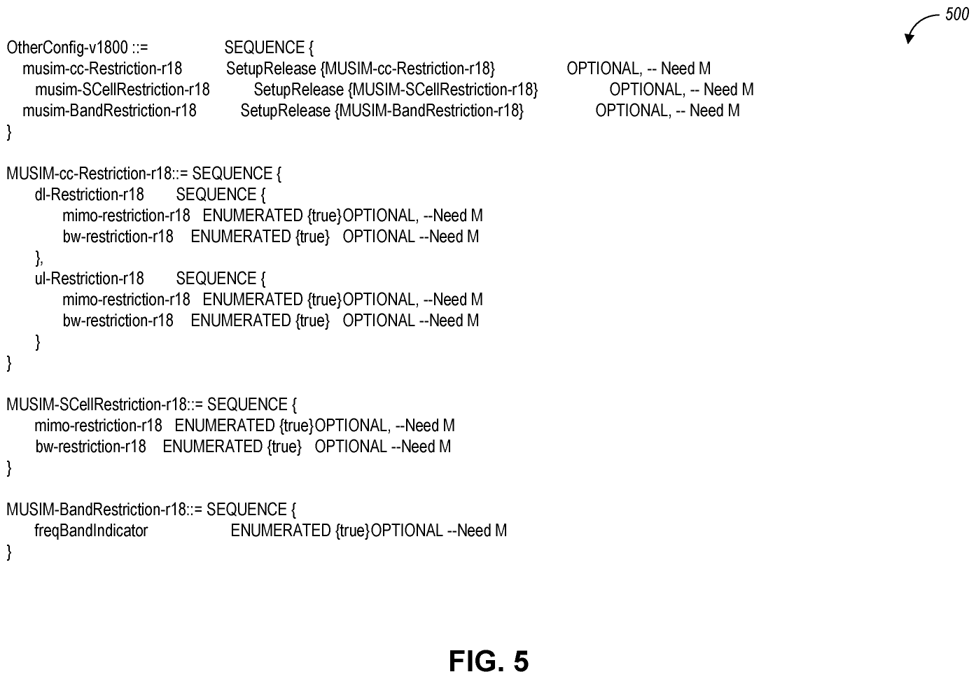

FIG. 5 illustrates an example ASN 500 of configuring an indication in RRC signaling as part of UE assistance information, in accordance with some aspects.

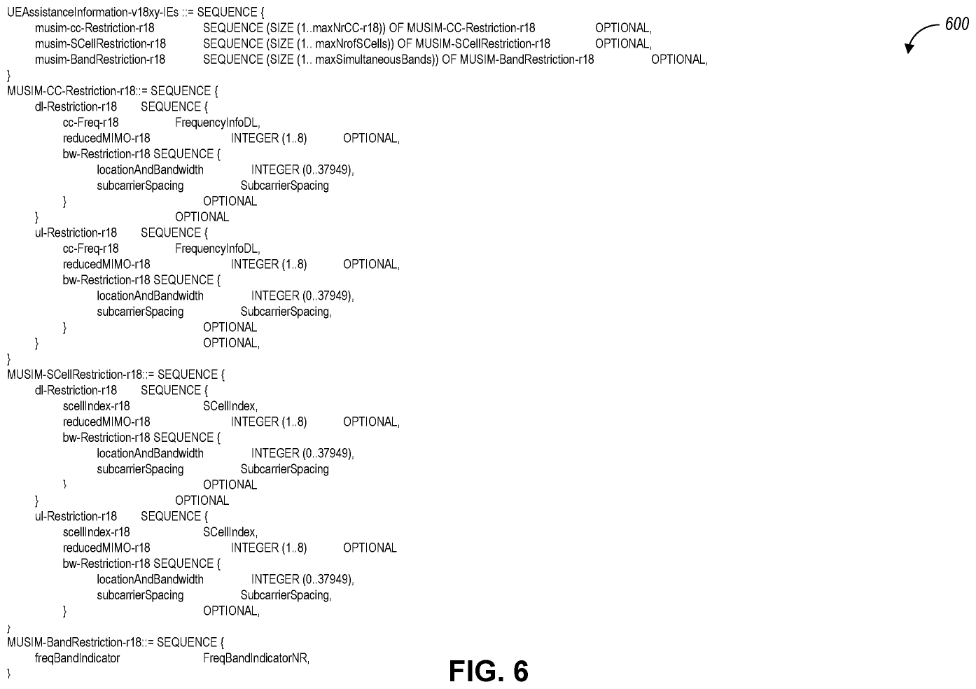

FIG. 6 illustrates an example ASN 600 of configuring an indication in RRC signaling as part of UE assistance information, in accordance with some aspects.

For the case where the restriction could be on a CC is not currently configured but could potentially be configured in the future, it could be sufficient in terms of delay to provide the restriction for that CC using an RRC message since NW A is not using it yet and UE can use it for NW B immediately before the completion of the signaling in network A.

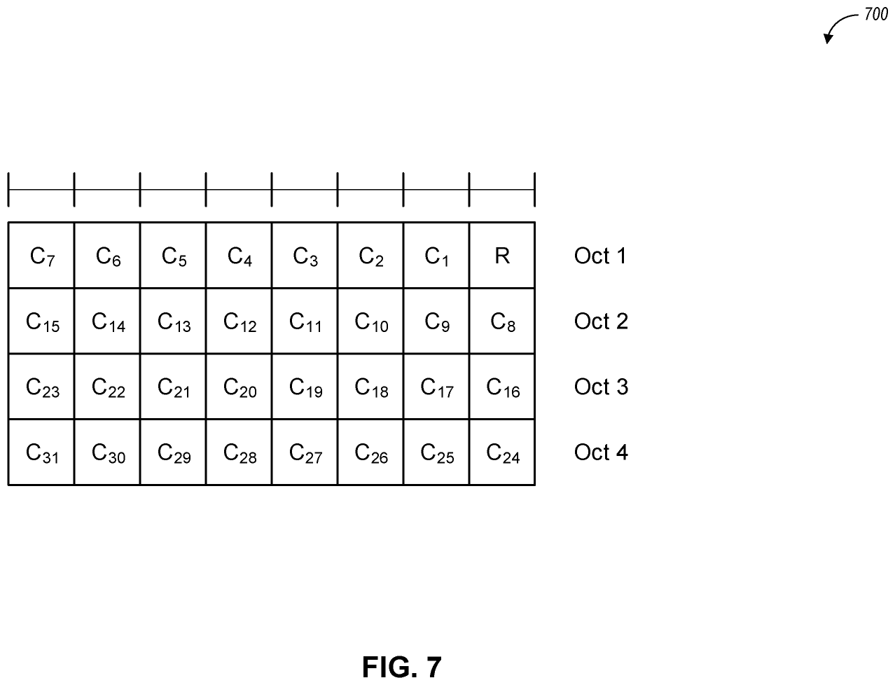

However, in the case the CC is configured (i.e., already configured as an SCell), while the use of RRC is still possible as discussed above, there may be a need to indicate it faster to the network so that it can be used by the UE connection to NW B quickly. In this case, an indication in the MAC signaling can be used (i.e., in a MAC CE). An example of such MAC CE is provided in FIG. 7.

FIG. 7 is a diagram of a MAC CE 700 to indicate a SCell affected by a network (NW) (e.g., NW B), in accordance with some aspects.

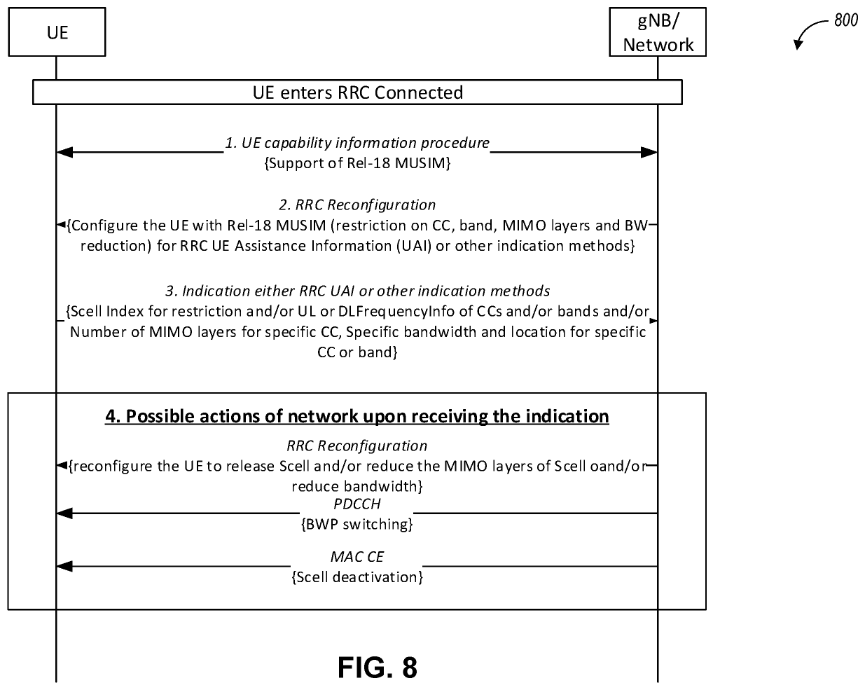

FIG. 8 is a diagram of an example message sequence 800 associated with the disclosed techniques, in accordance with some aspects.

Referring to FIG. 8, an example message sequence chart is shown below in the following steps (also illustrated in FIG. 8):

Step 1. The UE enters RRC Connected state and provides UE capability information to the base station (including the UE support of Rel-18 MUSIM) if requested by the network.

Step 2. If the UE supports Rel-18 MUSIM and the network also supports it, it may configure the UE with Rel-18 MUSIM configurations (i.e., whether the UE is allowed to request for which CCs and/or SCells and/or bands that are restricted and/or the number of MIMO layers within a CC/SCell/band to reduce and/or the bandwidth and location of a CC/SCell band).

Step 3. When the connection in NW B requires the restriction of UE configuration from NW A, the UE can indicate the temporary UE capability restriction by indicating certain configuration is not preferred based on the Rel-18 MSUIM configuration in Step 2.

Step 4. Upon receiving the indication from UE, the network can perform either an RRC Reconfiguration to release an SCell and/or reduce the MIMO layers and/or reduce bandwidth or L1 signaling via PDCCH to perform BWP switching or MAC CE to deactivate SCell.

In some aspects, Steps 3 and 4 can be repeated while the UE is connected to NW A in RRC Connected mode depending on the changing configuration in network B. For example, if network B configures another CC, this may impose additional restrictions on acceptable configurations from network A. This may be signaled towards network A and network A may release that configuration. In some aspects, Step 3 can also indicate to the network that there is no restriction (e.g. when the connection or certain configuration to NW B is released). Prohibit timers (timers that prevent the UE from repeating the preference indication) may not prevent the UE from requesting such changes as the configuration in network B is asynchronous to procedures in network A and is unpredictable (i.e., the UE has no prior knowledge of what configuration will be used in network B and when).

In some aspects, if a cell does not support Rel-18 MUSIM procedures, the UE can be aware of this as network A will not provide the MUSIM configuration. The UE may not then provide the preference to the network. The UE may use any implementation-specific method to connect to network B. This configuration may be using any of the legacy procedures that are supported by the network such as overheating assistance information, or autonomously releasing the connection to A. When a UE is handed over to a cell that does not support Rel-18 MUSIM, the MUSIM configuration from the previous cell is released. The UE will then behave as mentioned above in a cell that does not support Rel-18 MUSIM.

In case of handover (HO) to a cell that supports Rel-18 MUSIM, the previously provided UE preference is transferred to the new cell and used by the new cell to provide/update/continue with the current UE configuration.

Any signaled UE preference is released by the network and UE when the UE goes to INACTIVE or IDLE mode.

In some aspects, the number of UE Assistance Information indications (UAIs) or any other form of UE feedback may be limited.

In some embodiments, the network can configure the UE on the number of restrictions that the UE can request for MUSIM or other purposes. Taking the above information, the network can limit the maximum number of CCs that the UE can request from the network, the maximum number of MIMO layers that can be reduced per CC, and the maximum bandwidth reduction per CCs.

In some aspects, the UE proactively providing the UE assistance to NW A for the capability that is used by NW B may result in unnecessary signaling overhead to NW A, particularly if this capability restrictions indicated by UE are not going to be configured by NW A. In some aspects, the usage of the same capability may not happen at the same time.

Another embodiment relating to limiting the UAIs or any other form of UE feedback is that network can optionally indicate the bands of concern (e.g., it can use to configure the UE) to the UE either in the configuration of the UE assistance or UE can infer it from the neighbor cell list in the SIB or a combination of the two. If the UE needs to restrict these bands in network A due to activity in NW B, the UE can proactively provide the UAI or other form of UE feedback to inform network A about the restriction. For other bands (i.e., the bands not included in the “bands of concern” by network A), the UE may not provide the UAI or other forms of UE feedback. This will limit the amount of signaling to network A as the restrictions on bands not of concern are not signaled.

In another embodiment, the UE does not have to proactively indicate the capability restriction to those bands when the NW B configuration restricts the use of those bands in network A. Instead, the UE only indicates the restriction when NW A attempt to configure CCs on those bands to the UE. When this happens, the UE can reject NW A's attempt to configure CCs on those bands that are restricted due to the current configuration already used by NW B. The UE can provide the UE assistance information indication with the restrictions to network A either in the rejection message itself or a separate message via the UAI or other form of UE feedback.

### Scenarios for Capability Restriction Request/UAI

In some aspects, the following scenarios can be considered where some form of capability restriction behavior may be triggered:

(a) Scenario 1: The UE is connected to NW A and is initiating a connection to NW B.

(b) Scenario 2: The UE is initiating a connection to NW A and is connected to NW B.

(c) Scenario 3: The UE is connected to NW A and NW B.

Each of the above scenarios is further discussed below.

Scenario 1: The UE is connected to NW A and is initiating a connection to NW B. The following sub-scenarios may occur as shown in Table 1 below.

TABLE 1

| NW A | NW B | Possible actions in NW A or NW B | |
|---|---|---|---|
| Connected, | Initiating connection | Possible UE actions in NW A: | |
| with SCell | (either RRC Setup or | a. | Request release of the SCell |
| | Resume), PCell is | | in NW A using UAI before |
| | incompatible with | | initiating a connection to |
| | NW A SCell | | NW B (consequence delay in |
| | | | establishing a connection) |
| | | b. | Switch to Rel-17 MUSIM |
| | | Possible UE actions in NW B: | |
| | | c. | Try establishing a connection |
| | | | in another frequency that is |
| | | | not restricted (e.g., down- |
| | | | prioritise the current highest |
| | | | frequency of NW B). |
| | | d. | Additionally: |
| | | Indicate incapability of CA/DC | |
| | | during Connection req. in NW | |
| | | B. | |
| | | Indicate full capability | |
| | | restriction in UAI after security | |
| | | activation. Network B to only | |
| | | configure CA/DC after receiving | |
| | | this indication | |
| Connected, | Initiating connection, | Possible UE actions in NW A: | |
| with only | PCell is incompatible | a. | Switch to Rel-17 MUSIM |
| PCell | with NW A Pcell or | Possible UE actions in NW B: | |
| | NW B doesn't | b. | Try establishing a connection in |
| | support MUSIM | | another frequency that is not |
| | | | restricted (e.g., down-prioritise |
| | | | the current highest frequency of |
| | | | NW B). |
| | | c. | Additionally: |
| | | Indicate incapability of CA/DC | |
| | | during Connection req. in NW B. | |
| | | Indicate full capability restriction in | |
| | | UAI after security activation. | |
| | | Network B to only configure | |
| | | CA/DC after receiving this | |
| | | indication | |
| Connected | Initiating connection, | Possible UE actions in NW A: | |
| | no incompatibility | Send a UAI proactively to NW A to | |
| | | inform of any possible capability | |
| | | restriction | |
| | | Possible UE actions in NW B: | |
| | | Indicate possible incapability of | |
| | | CA/DC during Connection req. in | |
| | | NW B. | |
| | | Indicate full capability restriction in | |
| | | UAI after security activation. | |
| | | Network B to only configure | |
| | | CA/DC after receiving this | |
| | | indication | |
| Connected | Idle/Inactive and | Possible UE actions in NW A: | |
| (Only PCell) | camped on a cell | a. | Proactively send a UAI with |
| | which may be | | the restrictions that would |
| | affected by a | | apply in NW A if the UE |
| | configuration in NW | | went to connect in NW B in |
| | A when the UE | | the camped cell based on the |
| | initiates connection in | | cell UE is camping on in NW |
| | NW B on the camped | | B |
| | cell (as PCell) or | | |
| | when it resumes with | | |
| | the suspend | | |
| | configuration in | | |
| | NWB | | |
| Connected (Only PCell); | I | Possible UE actions in NW A: | |
| UE receives a | Idle/Inactive and | a. | Reject the reconfiguration of |
| configuration that it will | camped on a cell | | the SCell in NW A when it is |
| be able to support if it | which will affect the | | configured based on cell UE |
| goes to connected in | received | | is camping on in NW B |
| NW B in the cell it is | configuration in NW | | (Reactive) |
| camping on | A when the UE | a. | Accept the configuration and |
| | initiates connection in | | immediately send a UAI |
| | NW B on the camped | | providing the restricting to |
| | cell (as PCell) or | | NW A received the use of |
| | when it resumes with | | SCell in NW A proactively |
| | the suspend | | based on cell UE is camping |
| | configuration in | | on in NW B |

NWB

Scenario 2: The UE is initiating a connection to NW A and is connected to NW B. The following sub-scenarios may occur as illustrated in Table 2 below.

TABLE 2

| | | Possible UE actions in NW A |
|---|---|---|
| NW A | NW B | or NW B |
| Receives configuration | Connected | Possible UE actions in NW A: |
| during connection | | Prevent this scenario by indicating |
| establishment that is | | incapability of CA/DC during |
| not compatible with | | Connection req. in NW A. Follow |
| configuration in NW B | | up with subsequent full capability |
| (e.g. CA or SCG) | | restriction (UAI) after security |
| | | activation. Network to only configure |
| | | CA/DC after this |
| Resuming with a | Connected | Possible UE actions in NW A: |
| stored configuration | | Indicate release/incapability of |
| not compatible with | | CA/DC during Resume req. to |
| configuration in | | NW A. Follow up with subsequent |
| NW B (e.g. CA or | | full capability restriction |
| SCG) | | (UAI) after resume. Network to |
| | | only configures CA/DC after this. |
| | | UE may autonomously release the |
| | | CA/DC configuration or network A |
| | | may release it in the Release message |

Scenario 3: The UE is connected to NW A and NW B. The following sub-scenarios may occur as illustrated in Table 3 below.

TABLE 3

| NW A | NW B | Possible UE actions in NW A or NW B | |
|---|---|---|---|
| Connected; UE | Connected; | Possible UE actions in NW A: | |
| receives configuration | NW B does not | a. | Reject reconfiguration request to NW |
| that is not compatible | support | | A |
| with UE capability | MUSIM or UE | b. | Prevent this scenario: Send UAI with |
| based on the | only has PCell | | capability restriction proactively (i.e., |
| configuration in NW B | | | as soon as UE is aware of some |
| | | | restriction to NW A due to a |
| | | | configuration in NW B) to NW A to |
| | | | prevent this scenario from being in- |
| | | | compatible configuration |
| Connected; UE | Connected; | Possible UE actions in NW B: | |
| receives configuration | NW B supports | a. | Send UAI with capability restriction. |
| that is not compatible | MUSIM and | | Delays complete message to NW A |
| with UE capability | UE with | | until reconfiguration in B is complete |
| based on the | CA/DC | Possible UE actions in NW A: | |
| configuration in | configuration | b. | Prevent this scenario: Send UAI with |
| NW B | in NW B | | capability restriction proactively (i.e., |
| | | | as soon as UE is aware of some |
| | | | restriction to NW A due to a |
| | | | configuration in NW B) to NW A to |
| | | | prevent this scenario from being in- |
| | | | compatible configuration |
| Connected | Receives | Possible UE actions in NW A: | |
| | reconfiguration | a. | Proactively indicate to N/W A about |
| | that impacts | | reduction in capability |

| | |
|---|---|
| capability in | This can result in too much and unnecessary |
| NW A that | signaling to NW A every time there is a |
| could restrict | configuration change in NW B, if NW A |
| future | may never use that restricted configuration. |
| configuration | |
| but not current | |
| NW A | |
| configuration | |

Based on the above analysis of Scenarios 1-3, the possible actions related to the UAI can be listed as follow:

(a) The UE sends UAI reactively to the first network to indicate that the current configuration cannot be supported and to request a change in the current configuration. This could be due to the reception of configuration in the second network.

(b) The UE sends UAI proactively to the first network to indicate that it has some capability restrictions that can impact future configurations in the first network. This could be due to the reception of configuration in the second network's current configuration.

(c) The UE sends UAI or reject message reactively to the first network to indicate that the configuration requested in the reconfiguration message in the first network cannot be supported. This could be due to the current configuration in the second network being incompatible with the received configuration in the first network.

(d) The UE sends release/incapability of CA and/or DC during connection/resume requests to the first network. The UE may subsequently follow up with full capability restriction (UAI) to the first network after security activation. Subsequently, the first network may only configure CA/DC. This could be due to a configuration in the second network restricting CA/DC configuration in the first network.

In some aspects, the UE may send the UAI reactively or proactively. A reactive approach may result in a delay in the reconfiguration or increase the possibility of reconfiguration rejection.

In some aspects, in any of the previous messages, the UE could indicate restrictions to CA, DC, MIMO Layers, bandwidth, etc.

One embodiment as in Scenario 2 is that the UE can indicate release/incapability of CA/DC during connection/resume request to the network so that the network knows that there is a possible restriction on the UE capabilities and hence can wait until the UE provides the UE cap restriction before reconfiguring the UE further, e.g., for higher throughput via CA or SCG, MIMO Layers, bandwidth, etc. Such indication can be included in the RRC Setup or Resume Request message, or the RRC Setup or Resume Complete message.

In some aspects, the UE provides proactive UE assistance information regarding resources/capabilities that are not in use in the network (e.g., network A) to avoid any future incompatible configuration by the network (i.e., network A) where such resources/capabilities are in use by another network (e.g., network B). One main issue with UE proactively providing UE assistance to NW A is that it may result in unnecessary signaling overhead to NW A, particularly if the capability restrictions indicated by UE are not going to be configured (now or in the future) by NW A. Another embodiment is that NW A can optionally indicates the bands of concern (e.g., bands or CCs that it may configure) to the UE explicitly or implicitly (e.g., the neighbor cell list in the SIB, measurement objects). If the UE needs to restrict these bands in network A due to activity in NW B, the UE will proactively provide the UAI or other form of UE feedback to inform network A about the restriction. For other bands (I.e., the bands not included in the “bands of concern” by network A), the UE does not provide the UAI or other form of UE feedback. This may limit the amount of signaling to network A as the restrictions on bands not of concern are not signaled.

In some embodiments, the disclosed techniques can be based on providing UE assistance information to assist MUSIM and other purposes to allow UE to connect to two or more networks simultaneously by providing the capability restriction.

In some aspects, the UE provides bands and/or the DL frequency information and/or UL frequency information related to the component carrier and/or the bandwidths and the location of the bandwidths related to the CC and/or the number of MIMO layers that are affected by other networks (say network B) as UE assistance information to network A.

In some aspects, upon receiving the UE assistance information, network A avoids configuring the UE with configurations that relate to the UE assistance information or releasing and/or deactivating those configurations/resources.

In some aspects, once the configuration is no longer used by network B, the UE indicates the corresponding UE assistance to network A to release the restriction.

In some embodiments, as part of the configuration of the UE assistance information, network A can configure the number of bands, the number of CCs per band, the number of MIMO layers per CC/band, and the minimum bandwidth per CC/band that the UE can request as UE assistance.

In some aspects, the UE initiates the UE assistance information corresponding to the configurations/resources configured by network B to network A when network B configures the UE.

In some embodiments, the UE initiates the UE assistance information corresponding to the configurations/resources configured by network B to network A only when network B configures configuration/resources corresponding to the configuration/resources indicated by network A; otherwise, the UE does not initiate the UE assistance information.

In some aspects, the UE initiates the UE assistance information corresponding to the configuration/resources configured by network B to network A only when network A attempts to configure the configuration/resources affected by configuration/resources configured by network B.

In some aspects, the UE provides the UE assistance information as part of a rejection message to network A to reject the configuration/resources or as a separate message.

In some embodiments, the UE assistance information can be as an RRC message, such as MAC CE or L1 signaling in the DCI.

In some embodiments, the network infers from the UE assistance information (e.g., bands that are restricted) from UE to derive the band combinations that are no longer available.

In some aspects, the UE provides in the RRC Setup, Resume Request, or RRC Setup, or Resume Complete an indication to indicate to the network (e.g., Network A) whether the UE capability restriction may need to be applied for the connection.

In some aspects, on receipt of the said indication in claim 12, the network waits until it receives the full UE capability restriction before configuring the UE with CA/DC/MIMO, etc.

In some aspects, the UE provides proactive UE assistance information regarding resources/capabilities that are not currently in use in the network (e.g., Network A) to avoid any future incompatible configuration by the network (i.e., Network A) where such restriction could be due to resources/capabilities are in use by another network (e.g., Network B).

For UEs equipped with multiple radio transceivers, the interference power coming from a transmitter of the co-located radio may be much higher than the actual received power level of the desired signal for a receiver. This configuration may cause In-Device Coexistence (IDC) interference and is referred to as IDC problems. The disclosed techniques introduce Frequency Division Multiplexing (FDM) solution to solve IDC problems by using serving frequencies that are not affected by IDC problems.

The issue with the NR FDM solution for IDC is that the affected frequencies cannot be adequately indicated since the granularity is a serving frequency. This has an impact on network resource scheduling since UE cannot use a serving frequency even if only part of the frequency resource in a serving frequency is affected by IDC problems.

The disclosed techniques include an enhanced FDM solution for IDC to indicate finer granularity of frequency resources affected by IDC problems.

The disclosed techniques can improve radio resource usage efficiency when solving in-device coexistence issues between NR and other RATs (e.g., WiFi and Bluetooth).

### FDM Resource Indication Techniques

For FDM-related UE assistance information of IDC, resource indication granularity for a frequency affected by IDC problems can be one or more of Bandwidth Part (BWP), Physical Resource Block (PRB), or Resource Block Group (RBG). Alternatively, a separate configuration other than RBG can be used for enhanced FDM reporting.

If the granularity is RBG or PRB, the following several approaches can be considered for the indication signaling:

(a) A bitmap-based approach can be used. For example, a bitmap for the RBGs within the bandwidth can be reported per BWP.

(b) A start-length pair approach (similar to PDSCH/PUSCH resource allocation type 1) can be used. A straight-forward {start, length} can be signaled, or a more signaling-efficient way can be used. For example, ┌log₂(N_{BWP}^{size}(N_{BWP}^{Size}+1)/2)┐ bits (with N_{BWP}^{size} indicating the number of PRBs within the BWP) are needed if signaling is in the granularity of PRB. The actual resource indication is determined as follows. The signaled resource indication value (RIV) corresponds to a starting resource block (RBₛₜₐᵣₜ) and a length in terms of contiguously allocated resource blocksL_{RBS}. The resource indication value is defined by the following: if (L_{RBS}−1)≤└N_{BWP}^{Size}/2┘ then RIV=N_{BWP}^{size} (L_{RBS}−1)+RBₛₜₐᵣₜ else RIV=N_{BWP}^{size} (N_{BWP}^{size}−L_{RBS}+1)+(N_{BWP}^{size}−1−RBₛₜₐᵣₜ), where L_{RBs}≥1 and shall not exceed N_{BWP}^{size}−RBₛₜₐᵣₜ.

In some aspects, the above approach may be used when signaling is in the granularity of PRB. A similar approach can be used if granularity is RBG or other.

(c) As an extension of option b), multiple start-length pairs can be indicated.

### Indication of Affected Frequency Resource for Duplex Modes

In FDD, the DL and UL frequencies are different, and the affected frequency resource in DL and UL can be different. The enhanced resource indication method can be used for DL only (if UL is not affected), UL only (if DL is not affected), or both DL and UL (if both DL and UL are affected). In the case of the latter, separate indication can be used for DL and UL.

In TDD, the same frequency is used for DL and UL. There can be two different approaches for the indication of TDD.

In some aspects, a single frequency resource indication is used, and interference direction is indicated in addition.

Although the same frequency is used for DL and UL, the interference situation can be different depending on factors like different transmission power. Therefore, similar to the indication method in FDD above, the enhanced resource indication method can be used for DL only (if UL is not affected), UL only (if DL is not affected), or both DL and UL (if both DL and UL are affected). In the case of the latter, separate indication can be used for DL and UL.

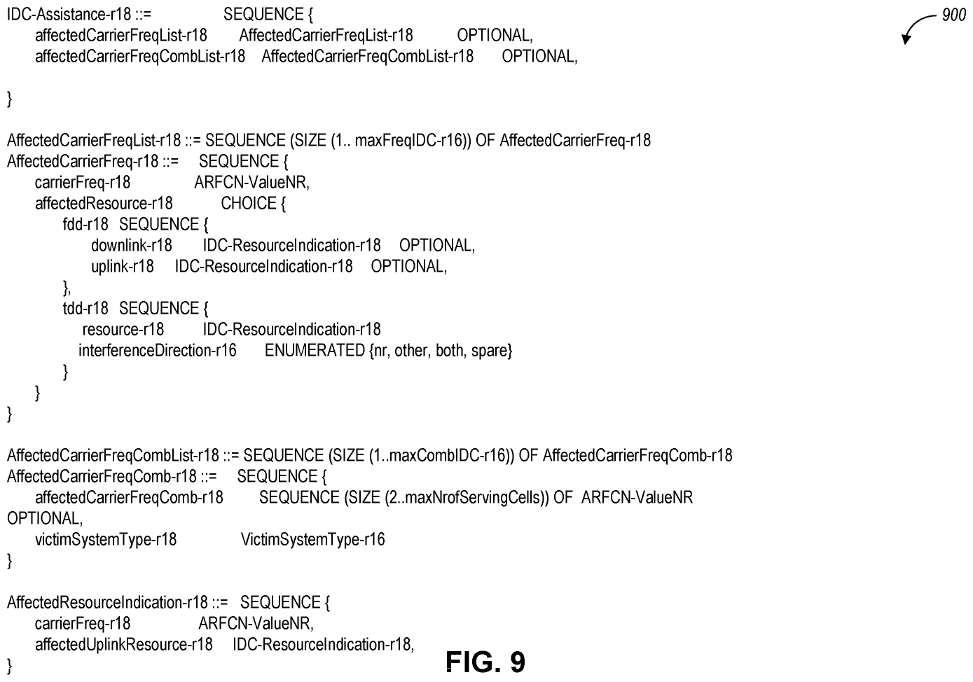

Taking into account the previous two sections on resource indication method and FDD, an example ASN.1 signaling structure is shown in FIG. 9. In the example, a single frequency resource indication is used for TDD.

FIG. 9 illustrates an example ASN 900 of configuring an indication of affected frequency resource for duplex modes, in accordance with some aspects.

### IDC Assistance Information for Non-Serving Frequencies

IDC assistance information can be provided for non-serving frequencies, according to Note 2 in TS 38.331 clause 5.7.4.2:

For a non-serving frequency, reporting IDC problems indicates an anticipation that if the non-serving frequency or frequencies became a serving frequency or serving frequencies then this would result in interference issues that the UE would not be able to solve by itself.

There is no information regarding the bandwidth/BWP of non-serving frequencies. The disclosed techniques can include the two options described below on how to use enhanced FDM solutions for non-serving frequencies:

(a) Option 1: additional information is provided by the gNB, e.g., BWP configurations, bandwidth information, RBG size configuration. Exact information depends on which granularity is selected for serving frequencies. Such additional information can be added by adding IEs to extend CandidateServingFreqListNR-r16 below.

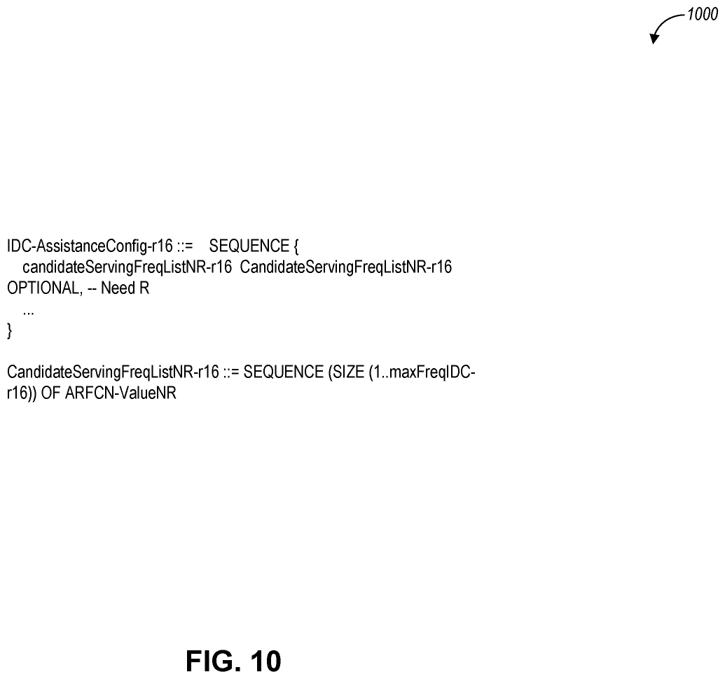

FIG. 10 illustrates an example ASN 1000 of configuring an indication of additional information provided by a base station, in accordance with some aspects.

(b) Option 2: The UE indicates the affected frequency resources assuming a fixed configuration, e.g., the BWP covers all PRBs, and a certain RBG size (an example is configuration 2 as in 3GPP TS 38.214 clause 5.1.2.2.1 for DL and 6.1.2.2.1 for UL).

In some embodiments, a UE in wireless communication systems includes circuitry to report UE assistance information for frequency resources affected by In-Device Coexistence problems with finer granularity than the carrier frequency. In some aspects, the Resource Block Group is the resource indication granularity. In some aspects, a bitmap is reported for the affected frequency resources of a carrier frequency. In some aspects, a start-length pair is reported for the affected frequency resources of a carrier frequency.

In some aspects, multiple start-length pairs are reported for the affected frequency resources of a carrier frequency. In some aspects associated with FDD, affected frequency resources are indicated for DL and UL independently.

In some aspects associated with TDD, affected frequency resources are indicated for DL and UL independently.

In some aspects associated with TDD, affected frequency resources and interference direction are indicated.

In some aspects, the affected frequency resources are indicated for non-serving frequencies.

In some embodiments, additional information is provided by the gNB for non-serving frequencies, e.g., BWP configurations, bandwidth information, and RBG size configuration.

In some aspects, the UE indicates the affected frequency resources assuming a fixed configuration.

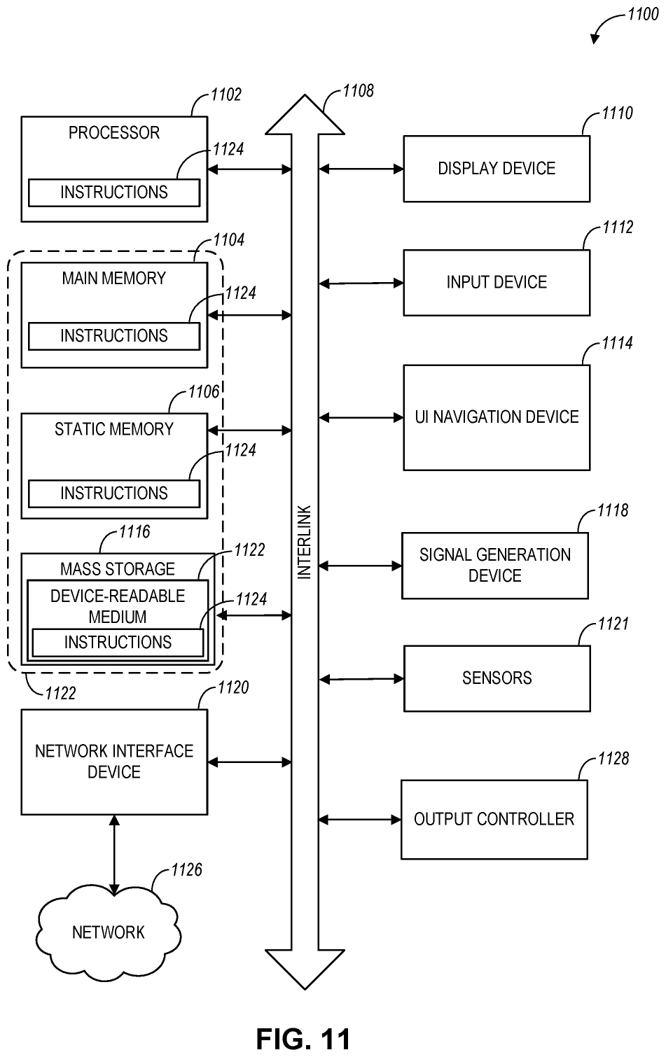

FIG. 11 illustrates a block diagram of a communication device such as an evolved Node-B (eNB), a new generation Node-B (gNB) (or another RAN node such as a base station), a network-controlled repeater (NCR), an access point (AP), a wireless station (STA), a mobile station (MS), or user equipment (UE), in accordance with some aspects and to perform one or more of the techniques disclosed herein. In alternative aspects, the communication device 1100 may operate as a standalone device or may be connected (e.g., networked) to other communication devices.

Circuitry (e.g., processing circuitry) is a collection of circuits implemented in tangible entities of the device 1100 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in the first circuit of a first circuitry at one point in time and reused by a second circuit in the first circuitry, or by a third circuit in a second circuitry at a different time. Additional examples of these components with respect to the device 1100 follow.

In some aspects, the device 1100 may operate as a standalone device or may be connected (e.g., networked) to other devices. In a networked deployment, the communication device 1100 may operate in the capacity of a server communication device, a client communication device, or both in server-client network environments. In an example, the communication device 1100 may act as a peer communication device in a peer-to-peer (P2P) (or other distributed) network environment. The communication device 1100 may be a UE, eNB, PC, a tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules needs not to be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1100 may include a hardware processor 1102 (e.g., a central processing unit (CPU), a graphics processing unit (GPU), a hardware processor core, or any combination thereof), a main memory 1104, a static memory 1106, and a storage device 1116 (e.g., hard drive, tape drive, flash storage, or other block or storage devices), some or all of which may communicate with each other via an interlink 1108 (e.g., a bus).

The communication device 1100 may further include a display device 1110, an input device 1112 (e.g., a keyboard), and a user interface (UI) navigation device 1114 (e.g., a mouse). In an example, the display device 1110, input device 1112, and UI navigation device 1114 may be a touchscreen display. The communication device 1100 may additionally include a signal generation device 1118 (e.g., a speaker), a network interface device 1120, and one or more sensors 1121, such as a global positioning system (GPS) sensor, compass, accelerometer, or another sensor. The communication device 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a device-readable medium 1122, on which is stored one or more sets of data structures or instructions 1124 (e.g., software) embodying or utilized by any one or more of the techniques or functions described herein. In some aspects, registers of the hardware processor 1102, the main memory 1104, the static memory 1106, and/or the storage device 1116 may be, or include (completely or at least partially), the device-readable medium 1122, on which is stored the one or more sets of data structures or instructions 1124, embodying or utilized by any one or more of the techniques or functions described herein. In an example, one or any combination of the hardware processor 1102, the main memory 1104, the static memory 1106, or the storage device 1116 may constitute the device-readable medium 1122.

As used herein, the term “device-readable medium” is interchangeable with “computer-readable medium” or “machine-readable medium”. While the device-readable medium 1122 is illustrated as a single medium, the term “communication device-readable medium” may include a single medium or multiple media (e.g., a centralized or distributed database, and/or associated caches and servers) configured to store the instructions 1124. The term “communication device-readable medium” is inclusive of the terms “machine-readable medium” or “computer-readable medium”, and may include any medium that is capable of storing, encoding, or carrying instructions (e.g., instructions 1124) for execution by the communication device 1100 and that causes the communication device 1100 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 1124 may further be transmitted or received over a communications network 1126 using a transmission medium via the network interface device 1120 utilizing any one of several transfer protocols. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of the single-input-multiple-output (SIMO), MIMO, or multiple-input-single-output (MISO) techniques. In some examples, the network interface device 1120 may wirelessly communicate using Multiple User MIMO techniques.

The term “transmission medium” shall be taken to include any intangible medium that is capable of storing, encoding, or carrying instructions for execution by the communication device 1100, and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Described implementations of the subject matter can include one or more features, alone or in combination as illustrated below by way of examples.

Example 1 is an apparatus for user equipment (UE) configured for operation in a Fifth Generation New Radio (5G NR) network, the apparatus comprising: processing circuitry, wherein to configure the UE for simultaneous connection to the 5G NR network and at least a second network, the processing circuitry is to: encode UE capability information for transmission to a base station of the 5G NR network, the UE capability information indicating the UE supports multiple universal subscriber identity module (MUSIM) operations; decode first radio resource control (RRC) signaling received from the base station, the first RRC signaling including a plurality of MUSIM configurations to configure the UE for the MUSIM operations; detect an interference between at least one MUSIM configuration of the plurality of MUSIM configurations and operation of the UE on the at least second network; and encode second RRC signaling for transmission to the base station, the second RRC signaling indicating a temporary UE capability restriction based on the interference; and a memory coupled to the processing circuitry and configured to store the first RRC signaling and the second RRC signaling.

In Example 2, the subject matter of Example 1 includes subject matter where the processing circuitry is to: decode the plurality of MUSIM configurations to determine at least one of a list of component carriers used by the MUSIM operations; a list of communication bands used by the MUSIM operations; a list of secondary cells (SCells) used by the MUSIM operations; a number of MIMO layers within a component carrier, an SCell, or a communication band associated with the MUSIM operations; and bandwidth reduction associated with the MUSIM operations.

In Example 3, the subject matter of Examples 1-2 includes subject matter where the processing circuitry is to: encode the second RRC signaling as UE assistance information (UAI) for transmission to the base station using a physical uplink shared channel (PUSCH).

In Example 4, the subject matter of Example 3 includes subject matter where the processing circuitry is to: encode the UAI to include at least one of one or more bands used by the operation of the UE on the at least second network; one or more downlink (DL) frequencies used by the operation of the UE on the at least second network; one or more uplink (UL) frequencies used by the operation of the UE on the at least second network; and one or more MIMO layers used by the operation of the UE on the at least second network.

In Example 5, the subject matter of Examples 1-4 includes subject matter where the processing circuitry is to: detect the at least one MUSIM configuration of the plurality of MUSIM configurations does not interfere with the operation of the UE on the at least second network.

In Example 6, the subject matter of Example 5 includes subject matter where the processing circuitry is to: encode third RRC signaling for transmission to the base station, the third RRC signaling including UE assistance information (UAI) indicating a release of the temporary UE capability restriction.

In Example 7, the subject matter of Examples 1-6 includes subject matter where the processing circuitry is to: encode third RRC signaling for transmission to the base station before detecting the interference and based on configuration of the UE by the at least second network, the third RRC signaling indicating at least one configuration associated with operation of the UE on the at least second network.

In Example 8, the subject matter of Examples 1-7 includes subject matter where the processing circuitry is to: encode the second RRC signaling to further include UE assistance information, the UE assistance information indicating frequency resources affected by in-device coexistence interference experienced by at least one transceiver within the UE.

In Example 9, the subject matter of Example 8 includes subject matter where the processing circuitry is to: encode the UE assistance information to include a bitmap of frequency resources of a carrier frequency, the frequency resources affected by the in-device coexistence interference.

In Example 10, the subject matter of Examples 1-9 includes, transceiver circuitry coupled to the processing circuitry; and one or more antennas coupled to the transceiver circuitry.

Example 11 is a computer-readable storage medium that stores instructions for execution by one or more processors of a base station, the instructions to configure the base station for simultaneous connection with a Fifth Generation New Radio (5G NR) network and at least a second network, and to cause the base station to perform operations comprising: decoding user equipment (UE) capability information received from a UE via the 5G NR network, the UE capability information indicating the UE supports multiple universal subscriber identity module (MUSIM) operations; encoding first radio resource control (RRC) signaling for transmission to the UE, the first RRC signaling including a plurality of MUSIM configurations to configure the UE for the MUSIM operations; and decoding second RRC signaling received from the UE responsive to the first RRC signaling, the second RRC signaling indicating a temporary UE capability restriction based on an interference between at least one MUSIM configuration of the plurality of MUSIM configurations and operation of the UE on the at least second network.

In Example 12, the subject matter of Example 11 includes, the operations further comprising: decoding the second RRC signaling to obtain at least one of one or more bands used by the operation of the UE on the at least second network; one or more downlink (DL) frequencies used by the operation of the UE on the at least second network; one or more uplink (UL) frequencies used by the operation of the UE on the at least second network; and one or more MIMO layers used by the operation of the UE on the at least second network.

In Example 13, the subject matter of Example 12 includes, the operations further comprising: encoding third RRC signaling for transmission to the UE, the third RRC signaling including one or more revisions to the plurality of MUSIM configurations based on the one or more bands, the one or more DL frequencies, the one or more UL frequencies, and the one or more MIMO layers indicated by the second RRC signaling.

Example 14 is a computer-readable storage medium that stores instructions for execution by one or more processors of a user equipment (UE), the instructions to configure the UE for simultaneous connection with a Fifth Generation New Radio (5G NR) network and at least a second network, and to cause the UE to perform operations comprising: encoding UE capability information for transmission to a base station of the 5G NR network, the UE capability information indicating the UE supports multiple universal subscriber identity module (MUSIM) operations; decoding first radio resource control (RRC) signaling received from the base station, the first RRC signaling including a plurality of MUSIM configurations to configure the UE for the MUSIM operations; detecting an interference between at least one MUSIM configuration of the plurality of MUSIM configurations and operation of the UE on the at least second network; and encoding second RRC signaling for transmission to the base station, the second RRC signaling indicating a temporary UE capability restriction based on the interference.

In Example 15, the subject matter of Example 14 includes the operations comprising: decoding the plurality of MUSIM configurations to determine at least one of a list of component carriers used by the MUSIM operations; a list of communication bands used by the MUSIM operations; a list of secondary cells (SCells) used by the MUSIM operations; a number of MIMO layers within a component carrier, an SCell, or a communication band associated with the MUSIM operations; and bandwidth reduction associated with the MUSIM operations.

In Example 16, the subject matter of Examples 14-15 includes the operations comprising: encoding the second RRC signaling as UE assistance information (UAI) for transmission to the base station using a physical uplink shared channel (PUSCH).

In Example 17, the subject matter of Example 16 includes the operations comprising: encoding the UAI to include at least one of one or more bands used by the operation of the UE on the at least second network; one or more downlink (DL) frequencies used by the operation of the UE on the at least second network; one or more uplink (UL) frequencies used by the operation of the UE on the at least second network; and one or more MIMO layers used by the operation of the UE on the at least second network.

In Example 18, the subject matter of Examples 14-17 includes, the operations comprising: detecting the at least one MUSIM configuration of the plurality of MUSIM configurations does not interfere with the operation of the UE on the at least second network, and encoding third RRC signaling for transmission to the base station, the third RRC signaling including UE assistance information (UAI) indicating a release of the temporary UE capability restriction.

In Example 19, the subject matter of Examples 14-18 includes, the operations comprising: encoding third RRC signaling for transmission to the base station prior to detecting the interference and based on configuration of the UE by the at least second network, the third RRC signaling indicating at least one configuration associated with operation of the UE on the at least second network.

In Example 20, the subject matter of Examples 14-19 includes, the operations comprising: encoding the second RRC signaling to further include UE assistance information, the UE assistance information indicating frequency resources affected by in-device coexistence interference experienced by at least one transceiver within the UE; and encoding the UE assistance information to include a bitmap of frequency resources of a carrier frequency, the frequency resources affected by the in-device coexistence interference.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

1-40. (canceled)

41. An apparatus for a user equipment (UE), the apparatus comprising: processing circuitry, wherein to configure the UE for Multi-Universal Subscriber Identity Module (MUSIM) operation in a Fifth Generation New Radio (5G NR) network, the processing circuitry is to:
encode first radio resource control (RRC) signaling for transmission to a base station, the first RRC signaling comprising UE capability information indicating the UE supports MUSIM capability restrictions;
decode second RRC signaling received from the base station, the second RRC signaling to reconfigure the UE for a MUSIM operation in the 5G NR network based on the UE capability information;
encode third RRC signaling for transmission to the base station, the third RRC signaling comprising UE assistance information, the UE assistance information indicating at least one MUSIM capability restriction of the MUSIM capability restrictions; and
perform a MUSIM procedure based on the at least one MUSIM capability restriction; and a memory coupled to the processing circuitry and configured to store the UE assistance information.

42. The apparatus of claim 41, wherein the at least one MUSIM capability restriction is a temporary component carrier (CC) restriction on one or more CCs configured for use during the MUSIM procedure.

43. The apparatus of claim 41, wherein the at least one MUSIM capability restriction is a temporary secondary cell (SCell) restriction on at least one SCell configured for use during the MUSIM procedure.

44. The apparatus of claim 41, wherein the at least one MUSIM capability restriction is a temporary bandwidth restriction on one or more bands configured for use during the MUSIM procedure.

45. The apparatus of claim 41, wherein the at least one MUSIM capability restriction is a temporary multiple-input-multiple-output (MIMO) restriction on at least one MIMO layer configured for use during the MUSIM procedure.

46. The apparatus of claim 41, wherein the processing circuitry is to:
decode an RRC Resume message received from the base station; and
encode an RRC Resume Complete message responsive to the RRC Resume message, the RRC Resume Complete message including an indication of the at least one MUSIM capability restriction.

47. The apparatus of claim 41, wherein the processing circuitry is to:
decode an RRC Setup message received from the base station; and
encode an RRC Setup Complete message responsive to the RRC Setup message, the RRC Setup Complete message including an indication of the at least one MUSIM capability restriction.

48. The apparatus of claim 41, further comprising:
transceiver circuitry coupled to the processing circuitry; and
one or more antennas coupled to the transceiver circuitry.

49. A non-transitory computer-readable storage medium that stores instructions for execution by one or more processors of a user equipment (UE), the instructions to configure the UE for Multi-Universal Subscriber Identity Module (MUSIM) operation in a Fifth Generation New Radio (5G NR) network, and to cause the UE to perform operations comprising:
encoding first radio resource control (RRC) signaling for transmission to a base station, the first RRC signaling comprising UE capability information indicating the UE supports MUSIM capability restrictions;
decoding second RRC signaling received from the base station, the second RRC signaling to reconfigure the UE for a MUSIM operation in the 5G NR network based on the UE capability information;
encoding third RRC signaling for transmission to the base station, the third RRC signaling comprising UE assistance information, the UE assistance information indicating at least one MUSIM capability restriction of the MUSIM capability restrictions; and
performing a MUSIM procedure based on the at least one MUSIM capability restriction.

50. The non-transitory computer-readable storage medium of claim 49, wherein the at least one MUSIM capability restriction is a temporary component carrier (CC) restriction on one or more CCs configured for use during the MUSIM procedure.

51. The non-transitory computer-readable storage medium of claim 49, wherein the at least one MUSIM capability restriction is a temporary secondary cell (SCell) restriction on at least one SCell configured for use during the MUSIM procedure.

52. The non-transitory computer-readable storage medium of claim 49, wherein the at least one MUSIM capability restriction is a temporary bandwidth restriction on one or more bands configured for use during the MUSIM procedure.

53. The non-transitory computer-readable storage medium of claim 49, wherein the at least one MUSIM capability restriction is a temporary multiple-input-multiple-output (MIMO) restriction on at least one MIMO layer configured for use during the MUSIM procedure.

54. The non-transitory computer-readable storage medium of claim 49, the operations comprising:
decoding an RRC Resume message received from the base station; and
encoding an RRC Resume Complete message responsive to the RRC Resume message, the RRC Resume Complete message including an indication of the at least one MUSIM capability restriction.

55. The non-transitory computer-readable storage medium of claim 49, the operations comprising:
decoding an RRC Setup message received from the base station; and
encoding an RRC Setup Complete message responsive to the RRC Setup message, the RRC Setup Complete message including an indication of the at least one MUSIM capability restriction.

56. A user equipment (UE) configured for Multi-Universal Subscriber Identity Module (MUSIM) operation in a Fifth Generation New Radio (5G NR) network, the UE comprising:
front-end circuitry coupled to one or more antennas;
processing circuitry coupled to the front-end circuitry, the processing circuitry is to:
encode first radio resource control (RRC) signaling for transmission to a base station, the first RRC signaling comprising UE capability information indicating the UE supports MUSIM capability restrictions;
decode second RRC signaling received from the base station, the second RRC signaling to reconfigure the UE for a MUSIM operation in the 5G NR network based on the UE capability information;
encode third RRC signaling for transmission to the base station, the third RRC signaling comprising UE assistance information, the UE assistance information indicating at least one MUSIM capability restriction of the MUSIM capability restrictions; and
perform a MUSIM procedure based on the at least one MUSIM capability restriction.

57. The UE of claim 56, wherein the at least one MUSIM capability restriction is a temporary component carrier (CC) restriction on one or more CCs configured for use during the MUSIM procedure.

58. The UE of claim 56, wherein the at least one MUSIM capability restriction is a temporary secondary cell (SCell) restriction on at least one SCell configured for use during the MUSIM procedure.

59. The UE of claim 56, wherein the at least one MUSIM capability restriction is a temporary bandwidth restriction on one or more bands configured for use during the MUSIM procedure.

60. The UE of claim 56, wherein the at least one MUSIM capability restriction is a temporary multiple-input-multiple-output (MIMO) restriction on at least one MIMO layer configured for use during the MUSIM procedure.
